(19) United States
(12) Patent Application Publication
(10) Pub. No.: US 2017/0080583 A1
(43) Pub. Date: Mar. 23, 2017

(54) WIRELESS KNIFE FOR CUTTING AND SPREADING COLD FOOD

(71) Applicant: FRANCISCO JAVIER ESTEBAN GONZALEZ, LAS NAVAS DEL MARQUES, AVILA (ES)

(72) Inventor: FRANCISCO JAVIER ESTEBAN GONZALEZ, LAS NAVAS DEL MARQUES, AVILA (ES)

(21) Appl. No.: 15/126,343

(22) PCT Filed: Apr. 1, 2015
(86) PCT No.: PCT/ES2015/000051

§ 371 Date: Sep. 15, 2016

(30) Foreign Application Priority Data
Apr. 2, 2014 (ES) U201400281

(51) Int. Cl. B26B 11/00

(52) U.S. Cl. CPC B26B 11/008

(57) ABSTRACT

The invention relates to a wireless knife for cutting and spreading cold food consisting of a knife equipped with a heating system that heats the blade at the moment of use thereof, characterized in that it comprises a blade, preferably consisting of stainless steel, titanium or the like, with a heating resistance insulated by sheets of mica, and a handle provided with a rechargeable battery that can be extracted by means of a screwed top arranged on the handle that has a hole that can be adjusted to the support projection of a charging base connectable to the mains by means of a cable and a plug. The handle has an electronic control plate, a secondary coil, a push button, a regulator and a tricolor light-emitting diode. The support projection has a primary coil which induces the secondary coil. The positions of the regulator correspond to the colours of the LED.

### OBJECT OF THE INVENTION

The present invention relates to a wireless knife for cutting and spreading very cold food.

The object of the invention is to provide a wireless knife that allows cutting and spreading food, in a cold or frozen condition, without any effort.

### BACKGROUND OF THE INVENTION

Conventional knives, regardless of their shape and dimensions, are designed to form a cutting means for food and materials. Knives of various configurations, provided with electrical means, are known to facilitate cutting but require wiring for connection to the electrical mains, which is a disadvantage from the point of view of periodic cleaning operations. However, the inventor is unaware of knives that work with full autonomy to facilitate cutting of materials such as cold or frozen food is although, at a given time, need to be recharged by connecting them to the mains.

### DESCRIPTION OF THE INVENTION

The wireless knife for cutting and spreading cold food presents the special feature of, once heated the blade, performing the cutting of frozen food and the spreading of very cold food with a small pressure, performing said cutting in a comfortable way and said spreading without physical effort.

The knife of the invention consists of three well distinct parts:

a blade

a handle

a charging base

In principle, the blade is made of stainless steel, but a choice can also be made between other light metals such as titanium or, in general, special alloys of high thermal conductivity.

Internally, it houses a flat resistance protected with sheets of mica.

The handle is hollow, made of plastic or similar material, anatomically shaped for a good hand coupling, being internally provided with a rechargeable battery connected to an inductive charging electronic circuit. Externally, it has a push-button and a voltage regulator illuminating a tricolor LED. All this in order to feed the internal resistance of the blade with more or less voltage, and to indicate, through the LED, a minimal, intermediate or maximum heating.

The charging base is one of a conventional inductive charging type that, with a lug for supporting the knife by its handle, is connected to the electrical mains although having no electrical contact with the handle in order to minimize possible hazards arising from handling with wet or damp hands.

The following drawings and detailed description of one preferred embodiment of the inventor, considered as an inseparable part of this document, will enable us to understand the operation and the structure of the various components of the wireless knife for cutting and spreading cold food.

### DESCRIPTION OF THE DRAWINGS

To complete the description of the invention and for a better and easier understanding of the characteristics of the invention, drawings are attached that show the following:

FIG. 1.—Shows a representation of a wireless knife for cutting and spreading cold food, with the metal cutting blade and the handle where the push-button, the regulator and the tricolor LED are installed.

The following items are indicated:

1.—handle

2.—push-button

4.—blade

7.—regulator

8.—tricolor Led

FIG. 2.—Shows the view of the same knife with a schematic detail of the contents within the same. The following elements are indicated, in addition to those in the previous figure:

3.—heating resistance

5.—rechargeable battery

6.—threaded cap

9.—sheets of mica

10.—electronic control board

11.—secondary coil

12.—cavity

FIG. 3.—Shows the knife assembly just before being coupled to the charging base. The following are indicated:

13.—charging base

14.—supporting lug

15.—primary coil

16.—cable

17.—Plug

### PREFERRED EMBODIMENT OF THE INVENTION

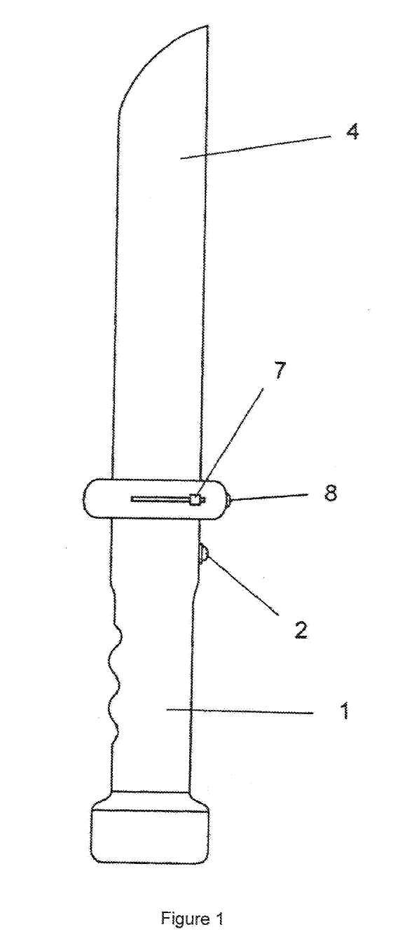

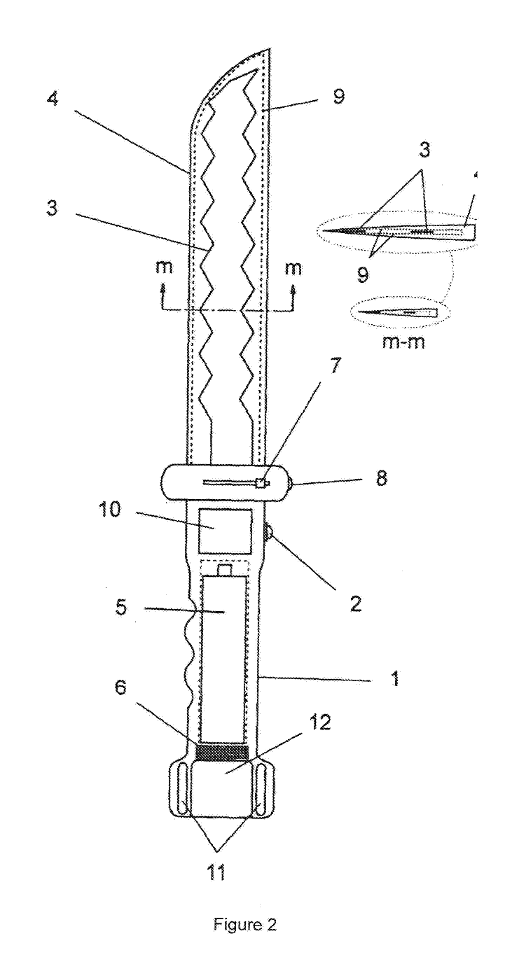

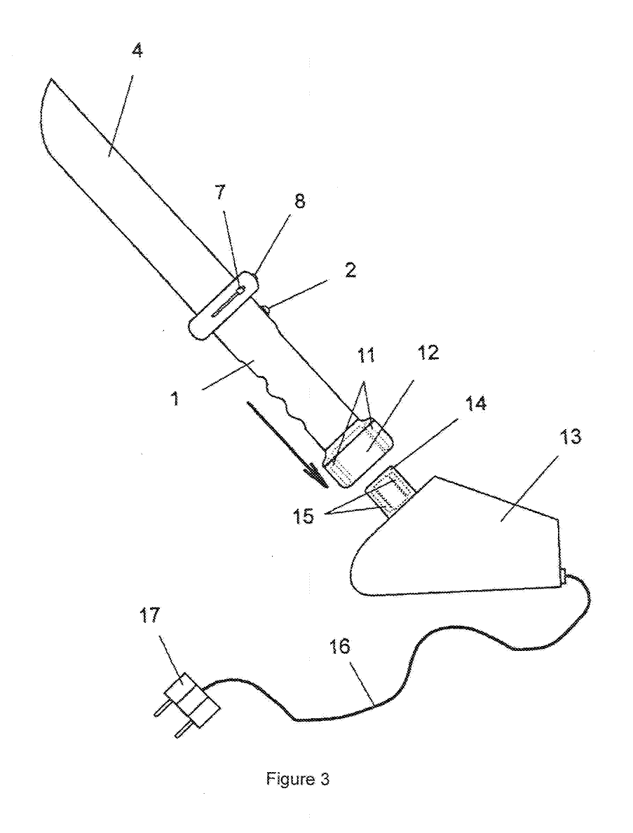

The wireless knife for cutting and spreading cold food (FIGS. 1, 2 and 3) is a knife of standard appearance which is internally provided with a heating system that heats the blade at the time of use and which, in a preferred embodiment of the inventor, is composed of a blade (4) inside which a heating resistance (3) is installed, properly insulated from the electrical viewpoint by sheets of mica (9) or any other similar material. The blade (4) is integral with a handle (1), preferably made of plastic, anatomically shaped for a more comfortable and safe handling, internally provided with a rechargeable battery (5) that can be extracted thanks to the existence of a threaded cap (6) which is situated at the handle (1) at its furthest end from the blade (4) where a cavity (12) is provided, as can be seen in FIGS. 2 and 3. The handle (1) further contains on its inside an electronic control board (10) and a secondary coil (11), having on its outside a push-button (2), a regulator (7) and a tricolor LED diode (8).

At those moments when not in use, the knife of the invention is placed on the charging base (13) (FIG. 3), by coupling the lug (14) in the cavity (12) of the handle (1). Although the charging base (13) can be used as a simple holder, it must be connected to the mains, through the cable (16) with conventional plug (17), at the time in which it is desired to fill the charge of the battery (5) interacting in that way the primary coil (15) of the charging base (13) with the secondary coil (11) present in the handle (1).

The long-life rechargeable battery (5) is the one that supplies electric power to the heating resistance (3) when the push-button (2) is actuated, resulting in the heating of the blade (4) for an easy cutting of cold food or even frozen food.

As the temperature of such food can vary very much, the invention includes, in principle, three possibilities in heating the blade (4) by placing the regulator (7) at one end of its travel, at the opposite end or at the intermediate point, such positions causing the switching on of the tricolor LED (8) in one of its colors. For example, it could be arranged the green color of the tricolor LED (8) for a lower temperature position, yellow color for the middle position of the regulator (7) and red color for the opposite position of the regulator (7) that is the one that produces the highest heating.

With the above description of the various components of the inventive knife with its charging base, it is easy to understand its mode of operation, always being controlled by the electronic control board (10).

The internal wiring of the different components will not be described as it is not characteristic of the invention although it meets, of course, those legal requirements established by the competent authority in this regard.

Briefly, it can be said that, when the rechargeable battery (5) is in the condition to be used, it is enough to remove the knife from the charging base (13), select the position of the regulator (7), press on the push-button (2) for a few seconds, and start cutting the food or the spreading process. If the heating is insufficient, it can be chosen to keep the push-button (2) pressed for a longer time or to change the position of the regulator (7) for more energetic heating.

It has been indicated that the handle (1) is made of plastic but it may be made of any other material that has enough strength and the required insulating characteristics. As for the blade (4), it is preferably made of stainless steel but any other metal could be used, such as titanium or a light alloy of high thermal conductivity.

The heating resistance (3) is made of common materials as the ones used in electric irons, with corresponding insulating materials to avoid any risk. In any case, it should be noted that risk, even with wet hands, is minimal if one takes into consideration the harmless power of the battery and the fact that the handling of the knife is always performed without any contact with the charging electrical mains.

It is not considered necessary to extend the content of this description for a person skilled in the art to understand its scope and the advantages derived from the invention, as well as to develop and implement the object thereof.

However, it should be understood that the invention has been described according to a preferred embodiment thereof, so it may be susceptible to modifications without implying any alteration of the scope of said invention, such modifications affecting to shape, size and/or manufacturing materials; that is, the terms in which this preferred description of the invention has been described should always be interpreted in a broad manner and without limitation.

1. A wireless knife for cutting and spreading cold food consisting of a knife of standard appearance internally provided with a heating system that heats the blade at the time of use, characterized in that it comprises a blade (4), preferably made of stainless steel, titanium or the like, inside which a heating element (3) is installed, insulated by sheets of mica (9) or any other similar material, a handle (1), preferably made of plastic and anatomically shaped, internally provided with a rechargeable battery (5) that can be removed by means of a threaded cap (6) located at the at the handle (1) at its furthest end from the blade (4) where a cavity (12) is provided allowing the insertion of the knife in the supporting lug (14) of a charging base (13) connectable to the mains via a cable (16) and a plug (17).

2. A wireless knife for cutting and spreading cold food according to claim 1, characterized in that inside the handle (1) an electronic control board (10) and a secondary coil (11) are installed having on the outside a push-button (2), a regulator (7) and a tricolor LED diode (8).

3. A wireless knife for cutting and spreading cold foods according to claim 1, characterized in that the supporting lug (14) of charging base (13) has therein a primary coil (15) that induces the secondary coil (11) when said charging base (13) is connected to the mains.

4. A wireless knife for cutting and spreading cold food according to claim 1, characterized in that the regulator (7) can assume three positions defining different degrees of heating of the heating resistance (3) whose positions correspond to each of the three colors of the tricolor LED (8).
